(19) United States
(12) Patent Application Publication
(10) Pub. No.: US 2013/0178980 A1
(43) Pub. Date: Jul. 11, 2013

(54) ANTI-COLLISION SYSTEM FOR MOVING AN OBJECT AROUND A CONGESTED ENVIRONMENT

(71) Applicants: Jerome Chemouny, Villeparisis (FR); Stephane Clerambault, Les Molieres (FR); Samuel Pinault, Chevreuse (FR)

(72) Inventors: Jerome Chemouny, Villeparisis (FR); Stephane Clerambault, Les Molieres (FR); Samuel Pinault, Chevreuse (FR)

(21) Appl. No.: 13/516,823

(22) PCT Filed: Dec. 17, 2010
(86) PCT No.: PCT/FR10/52805

§ 371 Date: Sep. 5, 2012

(30) Foreign Application Priority Data
Dec. 18, 2009 (FR) 0959224

(51) Int. Cl. B25J 9/16

(52) U.S. Cl. CPC B25J 9/1666
USPC 700/255

(57) ABSTRACT

An anti-collision system is provided for moving an object around an environment, the system including a processing unit connected to sensors capable of obtaining the position of the object in the environment in real time, the processing unit being provided with software and hardware for monitoring the object and for implementing: a virtual 3-D model of the environment, a real-time virtual 3-D model of the object moving around the environment, a virtual 3-D model of a virtual shell around the object, and an algorithm for real-time detection of collisions between the virtual shell and the modeled environment, a warning signal and an estimation of the collision being generated in the event of a virtual collision.

The present invention relates to a system for the movement of an object in an environment. It finds a particularly interesting application in robotic applications where a robot is used for handling, machining and/or welding operations where an electromechanical device is run in a cluttered environment.

The robotics world is not without danger. Robots are machines which move through space at speeds and accelerations which are sometimes high. As a result, there is a permanent danger in the environment thereof. The most important spatial danger is collision. A robot can injure a person by hitting him/her or be deteriorated by striking a rigid obstacle. Furthermore, the poly-articulation robots imply a wide range of possible movements, thereby increasing the risk of collision.

One object of the present invention is to provide a system enabling any collision during the movement of a robot to be prevented.

Another object of the present invention is to provide a system wherein movements of a positioning robot are efficiently and securely made.

At least one of the abovementioned objects is achieved with a collision avoidance system for the movement of an object in an environment; this system comprising a processing unit connected to sensors enabling the position of the object in the environment to be known in real time, this processing unit being provided with software and hardware means for controlling the object and for implementing:

an accurate virtual 3-D modeling of the environment,

a real-time virtual 3-D modeling of the movement of an object in the environment,

a 3-D modeling of a virtual envelope around the object, this virtual envelope forming a volume called a “dummy” volume, predicting the movements of the object, and

a real-time collision detection algorithm between the virtual envelope and the modeled environment, an alert signal being generated in the event of a collision and also a quantitative and qualitative assessment of this collision.

With the system according to the invention, a real collision avoidance system is made, allowing the movement of the object which may be a robot or any other complex electromechanical system in a cluttered environment without any risks for the operator, the robot itself and the onboard load. The invention allows an operator to use a complex electromechanical system intuitively.

The invention is particularly remarkable by the interaction of a 3-D engine and a physical engine of video games with industrial machines. These engines are connected to real electromechanical systems allowing a link between the virtual world and the real world. This connection is advantageous because it uses the computing power of 3-D engines to have a real-time virtual rendering of a robotic cell (or virtual world), and an optimum frequency of at least 60 Hz can be provided. The 3-D modeling is useful for the visual rendering of the scene and the high connection frequency allows a very good flexibility upon running the robot. The scene (the environment) and objects composing it can be formally described beforehand and designed object by object thanks to computer-aided design (CAD) methods. It can be contemplated that the virtual 3-D modeling of the environment further includes a virtual 3-D modeling of fixed and movable elements using sensors provided on these movable elements or in the environment.

A homothetic expansion is made on each CAD component generated. This volume expansion will not be materialized in the real world and will enable the collision between virtual volumes to be detected before it actually occurs. The CAD design of all the components of the scene has another advantage, namely to know each mass and center of inertia to be transmitted to the physical engine such that it can not only detect a collision on virtual volumes but also anticipate trajectories of the movable objects.

This connection is made feasible and reliable due to the addition in the real environment of a series of sensorial sensors. These measurement sensors can be placed on the robot or attached in the running environment thereof. They enable real-time position, speed and acceleration of the robot to be known.

Advantageously, the assembly of the physical engine software and the 3-D rendering of the scene is managed by a processing unit, parameterized so as to trigger, in response to a collision detection on one of the virtual volumes of the scene, an anti-collision process consisting in stopping or redirecting the movement of the object.

By way of example, due to the quickness of the processing unit and the optimization of high level algorithms used, the collision avoidance device is capable of performing at least 60 tests per second. This is a sampling sufficient for the whole invention to be considered as being a real-time system.

In the past, in an application using this kind of hardware, it was mandatory to put material barriers around these machines considered as very hazardous. Now, the growth of immaterial barriers and other security sensors makes it possible to remove material protections and to operate in the vicinity of a robot or even to interact with the machine.

According to an advantageous characteristic of the invention, an operator that may work in the vicinity of a robot or an electromechanical device could intuitively use such a device to help him/her in performing laborious tasks with a high security level. The invention, by having monitoring sensors in the real scene and improving virtual modeling techniques allows the operator to work with the robot in a complex environment to interactively perform a task which is laborious and complex to be programmed. Thus, this invention is applicable to activity areas requiring position accuracy of a tool, the operation to be performed (small scale production, medical applications . . . ) regularly changing, and of course the security for the operator, the machine and transported goods.

According to another advantageous characteristic of the invention, in order to diversify the use of a single robot, an automatic change of a tool attached to the robot through a pneumatic coupler can be carried out when a removable tool of the robot is detected in a predefined virtual volume of the environment. When this movable tool (transported for example on a carriage) is detected on the one hand by sensors (surveillance cameras or proximity sensors) and is located on the other hand in a defined virtual volume of the 3-D scene, a tool changing automatic procedure is started in order to provide the robot with this new apparatus.

According to an advantageous characteristic of the invention, the virtual modeling system of the environment and the collision avoidance device can be used for any automatic application of a robot in a complex scene. Indeed, even if there is no human to work in cooperation with the robot, objects of an industrial production are always movable and inevitably cause a foreseeable modification of the working scene. Previously described and coupled with the real world through sensors, the scene, thanks to the invention, can be a priori made secured in order to avoid any degradation in the production and the production tool itself.

The anti-collision system according to the invention is applicable in a non-limiting way to an industrial robot or to a patient positioning device in a treatment room.

According to a first exemplary implementation, an industrial robot is used which is generally intended for automatic and repetitive operations such as handling, welding and machining. According to an advantageous embodiment, the invention enables an operator to interact with a robot to safely perform tasks of the same nature but much more technically advanced. These tasks were previously hardly programmable and required staff highly skilled in robotics. Now, the present invention allows a use of these robots by staff skilled in the task to be carried out (for example welding) but not being an expert in robotics. The invention thus enables use of a robot with 6 degrees of freedom to be made transparent.

In addition to the above in particular, when the object is a poly-articulated robot, the system comprises at least one strain sensor, having 6 degrees of freedom for example, attached to this poly-articulated robot. This strain sensor is connected to a processing unit controlling the poly-articulated robot so as to perform a co-manipulation by following any strain detected (caused by the user).

More precisely, the strain sensor can comprise six strain gauges. The strains detected are transmitted to the processing unit (for example a computer) which processes them and sends back to the robot the movement control in the strain direction. This control loop allows a user to handle the tool without any mass constraint. Inertias and weight are compensated for by the robot. The possible movements are multiple and related to those of the robot. The purpose is in particular to move an object or a tool using the robot in co-manipulation so as to intuitively align it in front of an ad-hoc system. This method is intuitive because the strain exerted by a user on the robot is relayed by a movement under the control of the processing unit which controls an electromechanical system. This method further allows the positioning times to be reduced and a quick learning of working positions when starting the production.

Thus, the operator, being an expert in his/her application field can simply teach to the robot a “human” gesture which is hard to apply with standard point by point learning methods.

The strain sensor can also be used as a measurement of onboard load (mass and center of inertia). This measurement is used to set the control parameters to the co-manipulation, but also to get some idea of the deformations undergone by the robot and thus compensate for them.

Advantageously, this direct measurement of the sensor is automated and enables the invention to recover inertial information about an on board load on the robot. The present invention receives as a parameter the information about the real world using a strain sensor and the poly-articulated robot and transmits them in the virtual world. Thus, according to an advantageous embodiment, when it is decided to redirect the robot movement, the anti-collision process enables the manipulated tool to slide slowly on a set of volumes (walls of the robotic cell, operating support . . . ) which are potential obstacles.

More precisely, it is provided in the present implementation of the invention, a computer processing medium comprising algorithms executed by a microprocessor of a processing unit connected to a moving object, these algorithms implementing the following functionalities:

virtual 3-D modeling of the environment,

real-time virtual 3-D modeling of the object moving in the environment,

virtual 3-D modeling of an envelope around the object,

3-D modeling of a virtual envelope around the object, this virtual envelope forming a volume called a “dummy volume”, predicting the movements of the object, and

real-time detection of collisions between the virtual envelope and the modeled environment, an alert signal and a collision assessment being generated in the event of a virtual collision.

In the event of a virtual collision detection, that is a contact between two virtual protecting envelopes around static or mobile 3-D objects, a collision vector is generated by the processing unit (wherein information is available about the direction of the collision and the optimum direction of release). This vector is then transmitted by the application to the robot such that it deviates from its trajectory to avoid the collision (case of an automatic operating mode) or transmits, by a force feedback to the user, the optimum direction for the user to follow another path (case of a co-manipulation use). This method avoids the inopportune jerks in the robot trajectory. The user has a feeling of sliding which is a real assistance to manipulation and manual guidance of the robot.

Other advantages and characteristics of the invention will appear upon examining the detailed description of an embodiment in no way limiting, and the appended drawings, wherein:

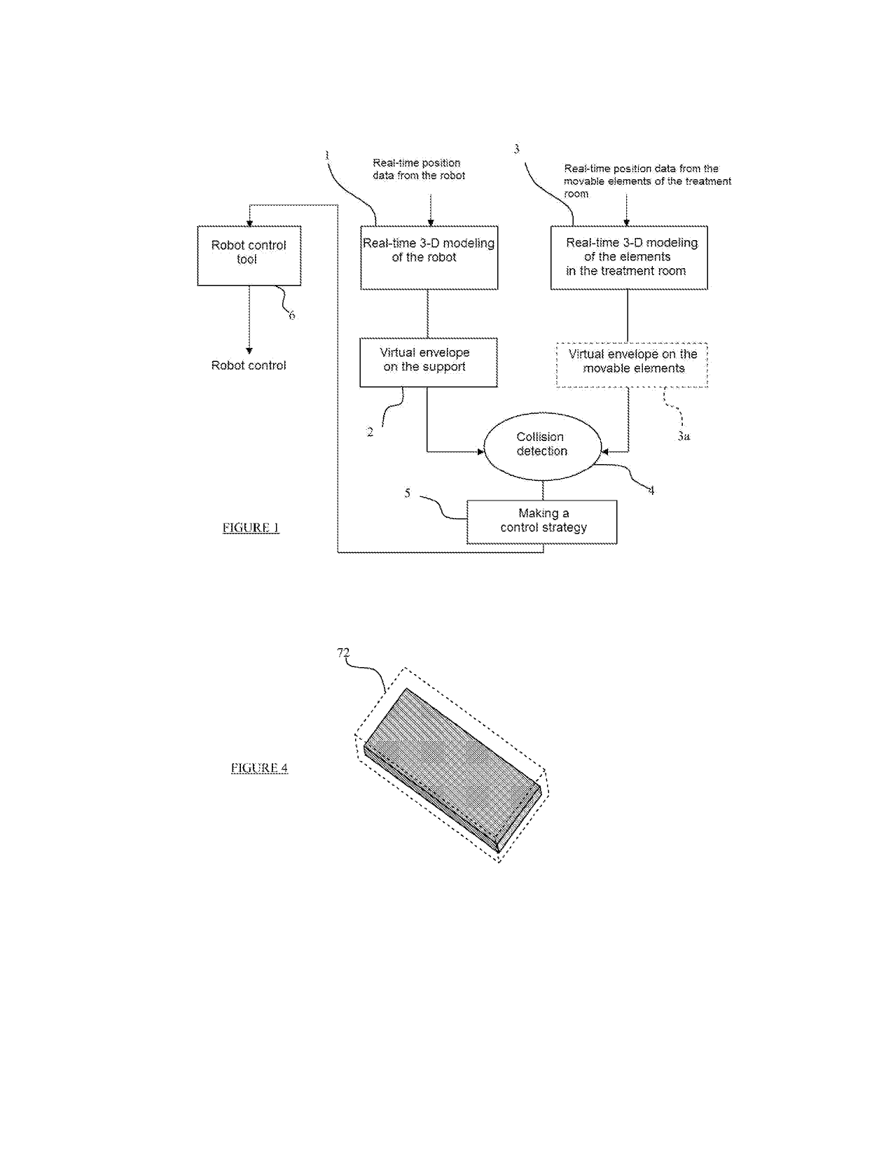

FIG. 1 is a flowchart schematically illustrating the time course of some processes of the system according to the invention,

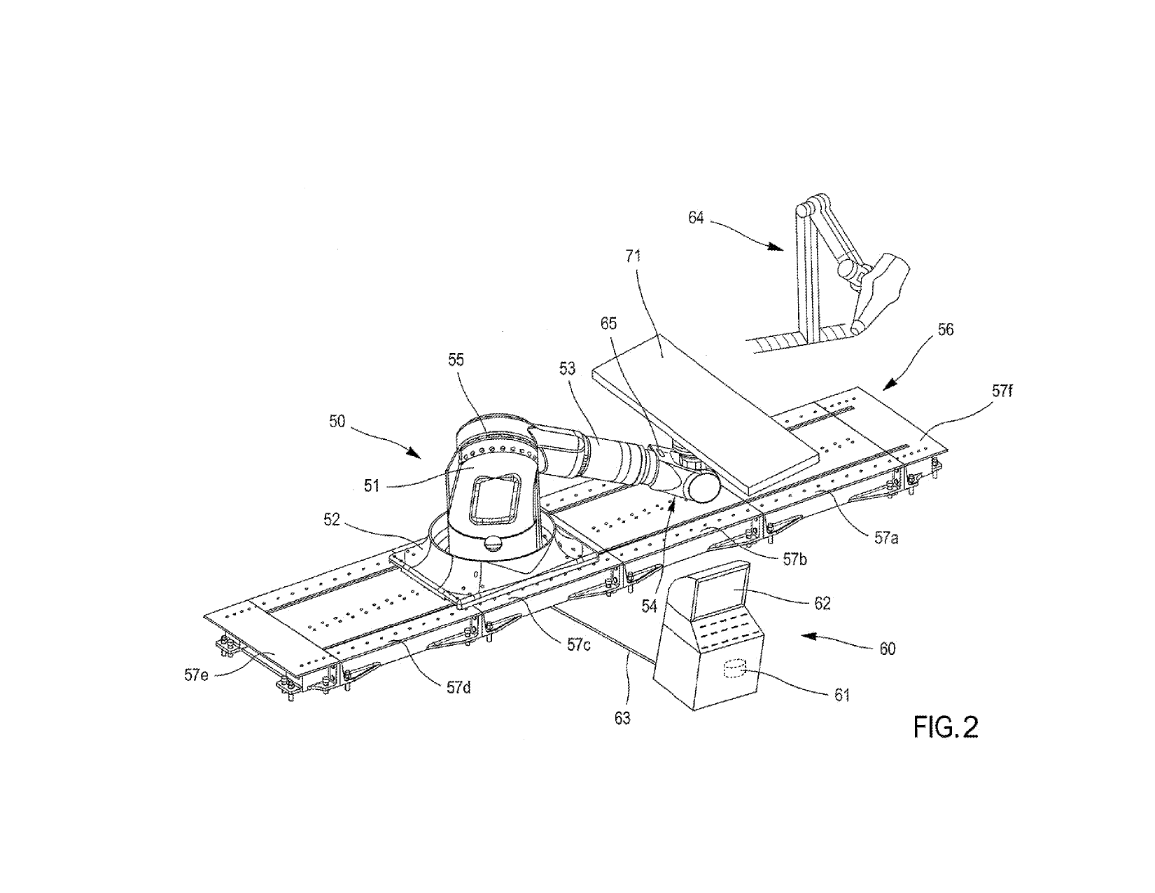

FIG. 2 is a schematic view of an anti-collision system applied to a positioning robot according to the invention,

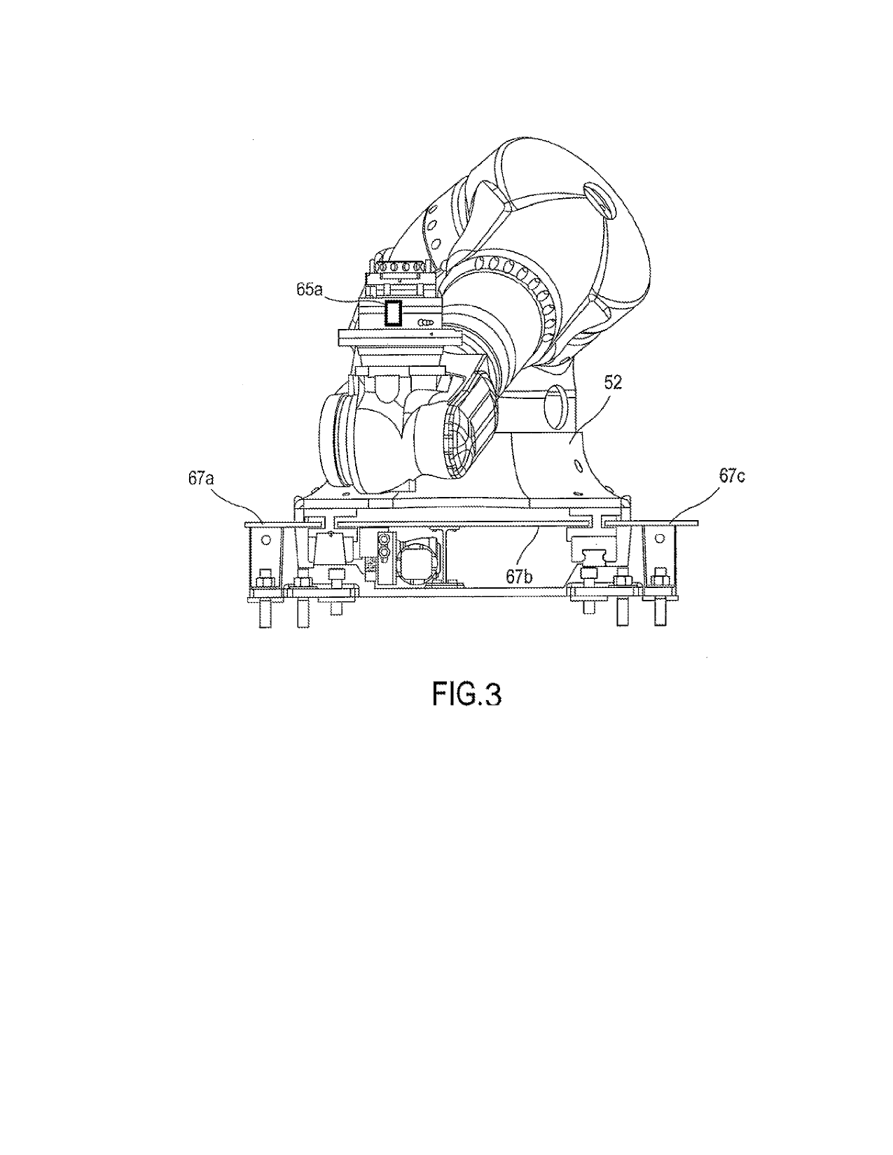

FIG. 3 is a side schematic view of the positioning robot of FIG. 2 without the patient support; and

FIG. 4 is a virtual representation of a patient support of the positioning robot of FIG. 2.

Even though the invention is not limited thereto, an anti-collision system according to the invention applied to a robot or positioning device of a patient in a treatment room will now be described.

A robot can be intended for positioning a patient with respect to an ionizing radiation during an external radiation therapy. Such a positioning robot is provided in a room dimensioned for such therapeutic treatments. This room is equipped with a particle accelerator which is capable of generating a radiation focused on the tumor to be treated in the patient's body. It will be readily understood that the positioning of the patient should be as accurate as possible, stable throughout the treatment and as reassuring as possible for the patient. The positioning robot is an articulated arm which carries a table or a chair or any other support means where a patient is installed. The positioning robot should be able to move the patient by avoiding any collision with fixed and movable elements present in the treatment room.

In FIG. 1, a flowchart schematically illustrating a time course of some processes of the system according to the invention can be seen. These processes are implemented in a processing unit such as represented in FIG. 2 in particular. It can also be seen that the processing unit includes in particular:
a tool for controlling the robot able to collect a set of information (positioning, operating state, . . . ) from the robot and to control the robot movements;
a real-time virtual 3-D modeling of the robot; this is a software application which determines the 3-D positioning of the robot through space, is able to display a representation as a virtual animated image of this robot and is capable of anticipating the the theoretical movement the robot will make, thereby predicting the possible collisions of the robot with its environment;
a virtual 3-D modeling of the environment, in particular of elements present in the treatment room; this is a software application which knows the arrangement of fixed elements in the room, which determines in real time the 3-D positioning of movable elements (other than the positioning robot) through space and which is able to display a representation as a virtual animated image of these elements;
a prediction of the movement of a movable object (robot or complex electromechanical system) according to the principle of a virtual “phantom” anticipating collisions, which is virtually moving with the real moving physical body. This volume is a dynamic representation of the aggregation of the expanded volume of each of the axes of the poly-articulated robot.

In operation, in step 1 of FIG. 1, the 3-D modeling of the positioning robot receives in real time positioning data of the positioning robot and determines its dynamics, namely its real-time running. In step 2, a virtual envelope is made on all or part of the patient support.

In parallel, in step 3, the 3-D modeling of the elements of the treatment room receives in real time positioning data from the movable elements (such as the focused radiation source for example) in the treatment room and determines its dynamics. In step 3a, a virtual envelope is optionally made on all or part of each of the movable and/or fixed elements. The movable elements are located in real time from data coming from sensors provided on these movable elements in the environment.

In practice, both virtual 3-D modelings are advantageously integrated in a single 3-D rendering which takes into account the interaction between different elements of the treatment room and the positioning robot.

In step 4, a collision detection algorithm is applied among several virtual objects at least one of which is moving. In particular, the collision detection is carried out between the virtual envelope made on the patient support and the elements of the treatment room or the virtual envelope of each of these elements if these elements have one.

In the event of a collision detection between virtual envelopes, that is when the real collision has not occurred yet, in step 5, a control strategy is made which will be applied by the control tool of the robot in step 6. This control strategy can consist in stopping the robot or determining a new trajectory enabling the real obstacle to be avoided.

In FIG. 2, an embodiment of the system according to the invention can be seen in a treatment room equipped with the positioning robot according to the invention as well as fixed and movable elements.

Preferably, the positioning robot of FIG. 2 is used comprising a joining part 50 sliding on a linear rail 56 and carrying a robotic arm 53 provided with a wrist 54 with concurrent axes of rotation.

The linear rail 56 is advantageously attached to the ground and consists of several modular elements 57a, . . . , 57d connected to each other. These modular elements can be identical so that the placement thereof in the treatment room is made easier. With such an arrangement, it is easy to make linear rails having different lengths.

In FIG. 3, a side view of the positioning robot of FIG. 2 can be seen without the patient support, each modular element 57a, . . . , 57d includes an upper metal plate (or any other solid material such as wood, plastics . . . ) 67a, 67b, 67c which are grooved and parallel. The grooves of an upper metal plate are aligned with grooves of the following metal plate.

The user can move safely on this floor consisting of the upper metal plates of the modular elements 57a, . . . , 57d. There are also two abutting modular elements 57e and 57f which are respectively provided at both ends of the linear rail 56.

The base 52 is associated with a part 51 pivotable about a vertical axis of rotation. The robotic arm 53 is rotatably connected to an upper part of the joining part 50 about an axis of rotation at an angle between 45° and 60° with respect to the horizontal. The wrist 54 bears a patient support 71 which can be very accurately positioned in the referenced frame of the treatment room.

According to the invention, a processing unit 60 enables a positioning device or robot to be electromechanically driven. Several engines are provided on and in the robot so as to control any joint of the robot automatically. A set of conventional sensors is provided on the robot such as for example an inclinometer 65 provided on the end effector 54. From the sensors and in particular the engines as well, the processing unit recovers a set of information enabling the robot positioning to be exactly known in real time. Namely, at each moment, the position and the orientation of the positioning support in the referenced frame of the room are known.

According to this implementation, the manipulation of the robot is improved by a co-manipulation process which consists in detecting a force applied to the end part of the robot and then in electromechanically controlling the same so as to promote the movement induced by this force. This force is generally applied by a user manually pushing for example the patient support.

In FIG. 3 for example, the sensor 65a can be a strain sensor used for detecting any strain applied on the end effector 54. This type of strain sensor can consist of six strain gauges. Several strain sensors distributed on several elements of the robot can be contemplated so as to grasp any strain applied on this robot. The latter principle is based on the real-time control of the current consumption of each engine of the electromechanical device (robot) when the latter is under control.

The processing unit comprises a computer type material part provided with conventional elements for acquiring digital and analogue data and processing this data. Said unit integrates a 3-D viewing module which determines and then displays on a screen 62 a 3-D representation of the robot movement with respect to the environment which is the treatment room. Advantageously, it also includes a modeling of the virtual envelope around the support 71 of the robot as well as a real-time collision detection algorithm between the virtual envelope and the modeled environment.

Advantageously, the processing unit is connected to the robot and to the radiation device 64 in a wired 63 or wireless manner, such that the 3-D viewing module can represent any movable apparatus in the treatment room.

Modelings are obtained from real-time acquired data and predetermined data. The latter come from a description of the objects using computer-aided design (CAD) tools and treatment positions being planned.

Furthermore, a virtual representation of a dynamic envelope, from inertia data of modeled objects or the measurement from a sensor (for example a strain sensor), which is predictive of the movements of the moving object, enables choices of trajectories to be anticipated.

To this end, it is contemplated that the virtual envelope follows the movement of the support 71. FIG. 4 is a virtual 3-D representation visible on the screen 62. Only the support 71 is represented for reasons of simplification. The virtual envelope 72 is of the same shape as the virtual representation of the support 71 but with higher dimensions. Consequently, when the support 71 is moving, the envelope 72 follows the same movement and any likely collision of the support 71 with one of the elements of the treatment room is preceded by a virtual collision of the envelope 72 in the 3-D viewing module. Indeed, the 3-D representation enables the system to be provided with a strategy for avoiding the support 71 when the virtual envelope 72 potentially virtually collides.

In FIG. 4, the envelope 72 encompasses the 3-D representation of the support 71, but this envelope 72 can be of a shape different from that of the support and of a lower size, in particular to monitor only one part of the support.

In practice, the viewing module can be implemented from a 3-D software engine in particular and techniques from the video games world (physical engine of collisions) for calculating collisions optimally. The collision detection comes from optimized powerful algorithms known to those skilled in the art:

“n-body pruning” type algorithm,

temporal coherence algorithm,

Gilbert-Johnson-Keerthi type distance algorithm.

These algorithms enable the collision detection speed to be increased. Therefore, at least 60 collision tests per second can be contemplated.

Such an anti-collision system has a lot of advantages:
securement of the patient transported by the robot in the event of a medical positioning device;
securement and protection of people circulating in the environment close to the robot;
protection system external to the normal operating line for the relevant hardware;
increase in the possible movements, the movable elements being protected from collision, and thus increase in the operators comfort as to the maneuverability of these elements.

An anti-collision system enables the capacity for using a movable system in space to be increased. For example, a medical robot is thus easily and safely maneuverable by the operator with no fear of a possible contact. Machines are therefore more autonomous, they ensure themselves their own security and that of their surroundings.

Of course, the invention is not restricted to the examples just described and numerous alterations can be provided to these examples without departing from the scope of the invention. A use of such a device can be easily contemplated in any industrial handling application. The purpose of the invention is to reduce risks of using a robot having 6 degrees of freedom by an operator without prior installation of safety material barriers. The purpose of the system according to the invention is to improve the user's safety and all the tools connected to the robot or in his/her environment and to simplify the daily use of a robot having 6 degrees of freedom by humans.

1. An anti-collision system for the movement of an object in an environment; said system comprising: a processing unit connected to sensors enabling the position of the object in the environment to be known in real time, said processing unit being provided with software and hardware means for controlling the object and for implementing:
a virtual 3-D modeling of the environment,
a real-time virtual 3D modeling of the object moving in the environment,
a 3D modeling of a virtual envelope around the object, this virtual envelope forming a volume called a “dummy” volume, predicting the movements of the object and
a real-time collision detection algorithm between the virtual envelope and the modeled environment; in the event of a virtual collision, an alert signal and an assessment of this collision being generated.

2. The system according to claim 1, characterized in that the virtual 3D modeling of the environment further comprises a virtual 3D modeling of fixed elements and a real-time virtual 3D modeling of movable elements using sensors provided on these movable elements or in the environment.

3. The system according to claim 2, characterized in that the software and hardware means are also configured to implement a virtual 3D modeling of a virtual envelope on at least one of the fixed or movable elements modeled, the collision detection being performed between virtual envelopes.

4. The system according to claim 1, characterized in that the volume of a virtual envelope is higher than the volume of the object or elements around which the virtual envelope is made.

5. The system according to claim 1, characterized in that the processing unit is parameterized so as to trigger, in response to the alert signal and the collision assessment, an anti-collision process consisting in stopping or redirecting the movement of the object.

6. The system according to claim 1, characterized by the use of a 3D engine and a physical engine of video games connected to real electromechanical systems providing,
an optimum frequency of at least 60 Hz, and
a system with a real-time refreshing.

7. The system according to claim 1, characterized in that the object is a poly-articulated robot, and the system comprises at least one strain sensor attached to this poly-articulated robot and connected to a processing unit controlling the poly-articulated robot so as to perform a co-manipulation by following any strain detected by said at least one strain sensor.

8. The system according to claim 1, characterized in that the object is a poly-articulated robot, and in that the so-called “dummy volume” is a dynamic representation of the aggregation of the expanded volume of each of the axes of the poly-articulated robot.

9. The system according to claim 1, characterized in that the object is a robot and the processing unit is configured to run an automatic procedure for changing a tool attached to the robot through a pneumatic coupler when a removable tool of the robot is detected in a predefined virtual volume of the environment.

10. A computer processing medium comprising: algorithms executed by a microprocessor of a processing unit connected to a moving object, said computer algorithms implementing the following functionalities:
virtual 3D modeling of the environment;
real-time virtual 3D modeling of the object moving in the environment;
3D modeling of a virtual envelope around the object, this virtual envelope forming a volume called a “dummy volume”, predicting the movements of the object; and
real-time detection of collisions between the virtual envelope and the modeled environment, an alert signal and a collision assessment being generated in the event of a virtual collision.

11. The computer processing medium according to claim 10, characterized in that the virtual 3D modeling of the environment further comprises a virtual 3D modeling of fixed elements and a real-time virtual 3D modeling of movable elements from data coming from sensors provided on these movable elements or in the environment.

12. The computer processing medium according to claim 11, characterized in that the execution of computer codes also implements a virtual 3D modeling of a virtual envelope at least on one of the fixed or movable elements modeled of the environment, the collision detection being made between virtual envelopes.
